(19) United States
(12) Patent Application Publication
(10) Pub. No.: US 2009/0294022 A1
(43) Pub. Date: Dec. 3, 2009

(54) ELECTRICAL DAMAGE DETECTION SYSTEM FOR A SELF-HEALING POLYMERIC COMPOSITE

(75) Inventors: Simon Hayes, Sheffield (GB); Frank Jones, Derbyshire (GB)

Correspondence Address: WILMERHALE/BOSTON, 60 STATE STREET, BOSTON, MA, 02109, US

(73) Assignee: UNIVERSITY OF SHEFFIELD, Sheffield (GB)

(21) Appl. No.: 11/577,968

(22) PCT Filed: Dec. 23, 2005
(86) PCT No.: PCT/GB05/05062

§ 371 Date: Jul. 8, 2009

(30) Foreign Application Priority Data
Jan. 7, 2005 (GB) GB0500241.5

(51) Int. Cl. B32B 43/00; G01N 27/20

(52) U.S. Cl. 156/94; 324/525

(57) ABSTRACT

A composite material provided with a damage detection system, the composite material comprising a fibre-reinforced polymeric matrix, wherein the fibre reinforcement comprises electrically conductive fibres and the polymeric matrix comprises a thermosetting polymer and a thermoplastic polymer, and wherein detection means are provided detect a change in resistance of the composite material, said change in resistance indicating the presence of at least one damaged area of the composite material, said detection means comprising a plurality of spaced apart electrodes mounted on an electrically insulating substrate and electrically connected to the electrically conducting fibres.

The present invention relates to damage detection, and more particularly to a composite material provided with a damage detection system, the material comprising a fibre-reinforced polymeric matrix.

Damage resulting from impact can cause a loss of 50-60% of the undamaged static strength of fibre reinforced polymeric matrices. The ability to repair a composite material mainly depends on two factors, early stage detection of the damage and accessibility. Detection of low velocity impact damage is very difficult and it is also difficult to access the resulting deep cracks in the composite material to facilitate repair. The damage can be divided into two types, macro-damage and micro-damage. Macro-damage mainly results from extensive delaminating, ply-buckling and large-scale fracture and can be visually detected and repaired with reasonable ease. However, micro-damage, which is barely visible, consisting of small delaminations, ply-cracks and fibre-fracture, occurs mainly inside the composite material, and is consequently much more difficult to detect and repair.

In most composite materials, the fibres bear the majority of the applied force. For low velocity impacts, the ability of the fibres to store energy elastically is of fundamental importance in ensuring excellent impact resistance. However the matrix also has a role in impact resistance. Non-destructive testing (NDT) methods have identified a number of failure mechanisms in polymer matrix composites, allowing the detection of barely visible damage. Such methods are at present essential for its identification and repair.

There are many different kinds of damage that can be present in an impact-damaged composite material. These include shear-cracks, delamination, longitudinal matrix-splitting, fibre/matrix debonding and fibre-fracture. The relative energy absorbing capabilities of these fracture modes depend on the basic properties of the fibres, the matrix and the interphase region between the fibres and the matrix, as well as on the type of loading. Fibre-breakage occurs in the fibres, matrix-cracking takes place in the matrix region, and debonding and delamination occur in the interphase region and are very much dependent on the strength of the interphase.

There are a variety of NDT inspection techniques available for the in-situ detection of impact damage in composite materials. These include visual inspection, ultrasonic inspection, vibrational inspection, radiographic inspection, thermographic inspection, acoustic emission inspection and laser shearography.

All of the above NDT damage detection techniques have some disadvantages and so have not proved 100% efficient, especially in the case of low velocity damage. These inspection techniques are time-consuming and are always carried out on a scheduled basis. If any damage occurs just after an inspection it will remain undetected until the next scheduled inspection, which may allow damage growth to occur and lead to catastrophic failure. Also, the inspection techniques are dependent on the skill of the operator to carry out the appropriate procedure. In the case of low velocity impact damage, barely visible impact damage frequently remains unidentified even after many scheduled inspections.

Smart sensors have been proposed to overcome the limitations of conventional NDT methods. These include optical strain gauges using Fabry-Perot interferometers, Bragg grating sensors and intensity based sensors operating on the principle that crack propagation will fracture an optical fibre causing a loss of light.

Electrical systems have also been proposed, for monitoring changes in the resistance or conductance of a composite. A resistance-based detection method is disclosed in an article by Hou & Hayes in Smart Mater. & Struct. 11, (2002) 966-969. This technique is based on the principle that, when damaged, a carbon fibre panel will show a greater resistance as compared to its pre-damaged state, allowing the damage to be detected. If the location of the change in resistance can be determined, damage location also becomes possible. The method involves the embedding of thin metallic wires at the edge of the composite material and monitoring the resistance between aligned pairs of wires. When damage occurs an increase in resistance is observed between pairs that are close to the damage. The entire disclosure of this article is incorporated herein by reference for all purposes.

Repair of defects in materials caused by in-service damage is generally necessitated by impact rather than by fatigue. Once the defect has been located by a suitable NDT method, a decision must be made as to whether the part should be replaced or repaired. Repair techniques vary greatly depending on the type of structure, materials and applications, and the type of damage. The options include bonded-scarf joint flush repair, double-scarf joint flush repair, blind-side bonded scarf repair, bonded external patch repair and honeycomb sandwich repair.

Thermoplastic matrix based composites are also susceptible to impact damage. These are usually repaired by fusion bonding, adhesive bonding or by mechanical fastening. Mechanical joints can also be made using conventional bolts, screws, or rivets, although care must be taken to ensure the fastener does not itself induce further damage.

There are a number of disadvantages of conventional repair techniques for polymer-based composite materials. For example, almost all of the above repair techniques require some manual intervention, and are therefore dependent on the skill of the repairer. As a result of these problems, composite materials have found limited use in areas such as consumer transport applications.

In UK patent application GB 0416927.2 there is described and claimed:

a. a self-healing composite material comprising a fibre-reinforced polymeric matrix, wherein the polymeric matrix comprises a thermosetting polymer and a thermoplastic polymer that together form a solid solution;

b. a method for producing a self-healing composite material, which comprises impregnating a layer, mat or tow of reinforcing fibres with a polymeric matrix comprising a thermosetting polymer and a thermoplastic polymer that together form a solid solution;

c. a self-healing composite material comprising a fibre-reinforced polymeric matrix, wherein the polymeric matrix comprises a thermosetting polymer and a thermoplastic polymer, and wherein detection means are provided to detect the presence and preferably the location of at least one damaged area of the composite material;

d. a self-healing composite material comprising a fibre-reinforced polymeric matrix, wherein the fibre reinforcement comprises carbon fibres and the polymeric matrix comprises a thermosetting polymer and a thermoplastic polymer, and wherein detection means are provided to detect a change in resistance of the composite material, said change in resistance indicating the presence of at least one damaged area of the composite material;

e. a method of detecting the presence of a damaged area in a self-healing composite material comprising a fibre-reinforced polymeric matrix, wherein the fibre reinforcement comprises carbon fibres and the polymeric matrix comprises a thermosetting polymer and a thermoplastic polymer, which comprises detecting a change in resistance of the composite material indicating the presence of at least one damaged area;

f. a method of repairing a damaged area in a self-healing composite material comprising a fibre-reinforced polymeric matrix, wherein the polymeric matrix comprises a thermosetting polymer and a thermoplastic polymer, which comprises heating the damaged area to the fusion temperature of the thermoplastic polymer for a time sufficient to promote damage repair; and

g. a self-healing polymeric matrix for a composite material, which comprises a blend of a thermosetting polymer and a thermoplastic polymer that together form a solid solution.

The entire disclosure of UK patent application GB 0416927.2 is incorporated herein by reference for all purposes.

The self-healing composite material with “on-board” damage detection means of UK patent application GB 0416927.2 represents a substantial advance over the prior art, but still suffers from the disadvantage that the contact wires are very fragile, making damage easy to inflict post manufacture. Inability to crop the edges of a panel of the composite material, as is common industry practice when producing components, is a further disadvantage. Finally the manufacturing process is very slow, due to the need to include each contact wire individually.

The present invention provides an improved composite material and damage detection system that is relatively robust and permits relatively fast manufacturing speeds.

In a first aspect, the present invention provides a composite material provided with a damage detection system, the composite material comprising a fibre-reinforced polymeric matrix, wherein the fibre reinforcement comprises electrically conductive fibres and the polymeric matrix comprises a thermosetting polymer and a thermoplastic polymer, and wherein detection means are provided to detect a change in a measurable characteristic of the composite material, said change in said measurable characteristic indicating the presence of at least one damaged area of the composite material, said detection means comprising a plurality of spaced apart electrodes mounted on an electrically insulating substrate and electrically connected to the electrically conducting fibres.

Preferably the detection means are adapted to detect both the presence and location of at least one damaged area of the composite material.

Preferably the electrically conducting fibres comprise carbon fibres and the electrodes are in electrical contact with the carbon fibres. In certain embodiments it may also be possible to use metal fibres, metal coated polymeric fibres, or other suitable electrically conductive fibres.

Preferably the plurality of spaced apart electrodes is disposed along one or more edge regions of the composite material.

Preferably the electrically conductive fibres are aligned axially and the electrodes are connected to opposed ends of the fibres, forming aligned pairs.

In one preferred embodiment the composite material comprises a laminate of two or more fibre reinforcing layers, each containing electrically conductive fibres, wherein the electrically conductive fibres of a first layer are aligned at an angle to the electrically conductive fibres of a second layer, and wherein each layer is separately provided with electrodes connected to its electrically conductive fibres. This requires the inclusion of an interleaf as outlined in Hou & Hayes in Smart Materials and Structures 11, (2002).

Preferably the electrodes are connected in use to a resistance, or other measurable characteristic, measuring and monitoring means having an output providing an indication of the position of an area of damage.

Preferably the electrically insulating substrate is flexible. It can, for example, comprise a polymeric sheet or film, especially a sheet or film of polymeric material of the type used for flexible printed circuit boards. Suitable electrically insulating polymeric materials include, for example, epoxies, polyimides and polyesters. The electrically insulating substrate may be reinforced with a fibreglass mat or other reinforcement as required. The electrically insulating substrate can be used as an interleaf to isolate the electrically conductive fibres from the composite if required.

The electrodes may be applied to the substrate by any suitable method. They can, for example, be laid down as thin strips of metal or electrodeposited onto the surface of the substrate. Alternatively the electrodes can be etched from a metal film, preferably a copper film, bonded to the electrically insulating substrate.

Preferably the electrodes are coated with an insulating lacquer after formation, leaving exposed only those areas necessary to make electrical contact where required.

Preferably the composite material is self-healing. By “self-healing composite material” in this specification is meant a composite material that is capable of substantial recovery of its load transferring ability after damage. Such recovery can be passive, for example, where the composite material comprises liquid resin that can flow and fill cracks, with subsequent hardening in place. Alternatively the recovery can be active, that is to say the composite material requires an external stimulus, for example, heating of the damaged area. In preferred embodiments of the invention, the self-healing composite material is capable of recovering 50% or more, 60% or more, 70% or more, or 80% or more, of its load transferring ability.

The composite material can be shaped to any desired form, for example, sheets, tubes, rods, and moulded articles. Preferably the composite material comprises a laminate of two, or more, reinforcing fibre layers impregnated with a polymeric matrix.

The reinforcing fibres can comprise, for example, carbon fibres, glass fibres, ceramic fibres, metal fibres, or mixtures thereof. Preferably the reinforcing fibres are laid in the form of a mat, an aligned layer or a tow. Especially where the reinforcing fibres comprise carbon fibres, these are preferably laid in one or more layers such that the fibres in each layer are axially aligned. Where more than one layer of axially aligned fibres is present, the layers are preferably arranged so that the axes of fibres in different layers lie at an angle to each other. The angle can, for example, be from 15° to 90°. The reinforcing fibres are preferably continuous, although healing is also achievable in short fibre composites containing any fibre type.

The composite material can also comprise a reinforcing material other than fibres, for example, organic and/or inorganic fillers. In certain circumstances these can replace the fibrous reinforcement wholly or partly, with the exception of the electrically conducting fibres.

The thermosetting polymer can be any suitable polymer into which reinforcement, and particularly reinforcing fibres, can be incorporated. Examples of suitable thermosetting polymers include phenolic resins; phenol-formaldehyde resins; amine-formaldehyde resins, for example, melamine resins; urea-formaldehyde resins; polyester resins; urethane resins; epoxy resins; epoxy-polyester resins; acrylic resins; acrylic-urethane resins; fluorovinyl resins; cyanate ester resins; polyimide resins and any other related high temperature thermosetting resin.

The thermoplastic polymer preferably has a fusion temperature or flow temperature significantly above ambient temperature, but not so high as to cause thermal breakdown of the thermosetting polymer. Preferably, the thermoplastic polymer has a fusion or flow temperature that is similar to the glass transition temperature of the thermosetting polymer, preferably in the range of Tg ±100° C., more preferably Tg ±50° C., most preferably Tg ±10° C.

In this specification, a “solid solution” is intended to denote a homogeneous mixture of two or more components which substantially retains the structure of one of the components.

The polymeric matrix preferably comprises at least 5% by weight of the thermoplastic polymer, more preferably from 5 to 50% by weight, most preferably from 10 to 30% by weight, based upon the total weight of the polymer matrix. In a preferred embodiment, the thermoplastic polymer is uniformly dispersed throughout the polymeric matrix, being wholly miscible with the thermosetting polymer. In this specification, such a dispersion of a thermoplastic polymer in a thermosetting polymer is referred to as a “polymer solution”. The invention is not, however, limited to polymer solutions, and in certain embodiments any matrix in which the thermoplastic polymer can bridge defects, for example, cracking, and thereby promote healing is also included. Examples of other suitable polymeric matrices include those comprising interleaved layers of thermoplastic polymer and thermosetting polymer, and composite materials with modified fibre polymeric coatings.

Suitable thermoplastic polymers for use with epoxy resins include, for example, polybisphenol-A-co-epichlorohydrin. Preferably the thermoplastic polymeric is miscible with the thermosetting polymer, but does not normally chemically react with it at ambient temperatures. In this way, a suitable thermoplastic polymer can be selected for any thermosetting polymer system.

Preferably the thermoplastic polymer forms a homogeneous solution with the thermosetting matrix, both before and after cure. This is a relatively rare occurrence for polymers, which generally display poor miscibility in each other, particularly as their molecular weight increases. Methods for determining suitable combinations are disclosed in UK patent application GB 0416927.2.

It is then necessary to ensure that the healing rate is acceptable, by careful selection of the molecular weight of the thermoplastic polymer and the healing temperature that is employed. As the healing process is thought to be a diffusional one, lower molecular weight will give more rapid diffusion and therefore quicker healing. However, the mechanical properties of the thermoplastic polymer improve with greater molecular weight. A balance therefore exists between rapid healing and good healed mechanical properties, which can in part be mitigated by using the healing temperature as a second variable. In order to select the optimum molecular weight of the thermoplastic polymer, the Tg of the thermosetting polymer must be taken into account as well, as it is necessary for the Tg of the thermoplastic polymer to be similar to that of the thermosetting polymer if healing is to be successful. For any compatible thermoplastic polymer the best compromise can be therefore be attained by consideration of the compatibility of the polymers (as laid out above), the Tg of the thermosetting polymer, the molecular weight of the thermoplastic polymer and the healing temperature that is to be employed.

The self-healing composite material can be produced, for example, by forming a solution of the thermosetting polymer and the thermoplastic polymer, impregnating a layer of reinforcing fibres with the polymer solution thus produced, and curing the thermosetting polymer.

The electrodes can be connected to suitable resistance measuring and monitoring means. The resistance measuring and monitoring means is capable of detecting changes in resistance of a composite material, which changes may result from damage to the fibres, the polymer matrix, or the interphase region. Where a plurality of layers of electrically conductive fibres is provided, and the electrically conductive fibres in separate layers are aligned at an angle to one another, the resistance measuring and monitoring means can also provide an output indicating the position of the area of damage by triangulation. A suitable resistance-based detection method is disclosed by Hou & Hayes in Smart Materials & Structures 11, (2002).

When the presence, and preferably also the location, of a damaged area in the self-healing composite material has been detected, the area can be healed, for example, by heating the damaged area to a temperature at or above the fusion temperature of the thermoplastic polymer. Without wishing to be constrained by any particular theory, it is believed that heating causes the thermoplastic polymer to fuse and flow, sealing cracks and restoring integrity to the composite material.

In a preferred embodiment of this aspect of the invention, the damaged area is heated by passing a current through electrically conductive fibres, at least in the damaged area. The heating fibres may be the same as the electrically conductive fibres of the detection means, or different fibres. The electrically conductive fibres in the damaged area have a higher resistance than electrically conductive fibres in surrounding areas and therefore will be preferentially heated, causing localised heating of the polymeric matrix in the damaged area. Preferably the damaged area is heated to a temperature of from Tg_{thermoplastic} to Tg_{thermoplastic}+75° C., more preferably in the range of Tg_{thermoplastic}+30° C. to Tg_{thermoplastic}+60° C.

Preferably the damaged area is heated for the shortest possible time that facilitates good healing. The actual heating time can be optimised empirically, and will depend on the molecular weight of the thermoplastic polymer, the Tg of the thermosetting polymer and the temperature employed for healing. In a preferred embodiment, this would require a heating regime that is completed in less than 1 hour and more preferably in less than 5 minutes. Those skilled in the art will be able to determine by simple experiment or observation the balance to be struck between the length of time necessary to obtain healing, and the temperature at which either structural rigidity is too greatly compromised, or chemical decomposition of one of the phases occurs.

Various embodiments of the invention will now be described and illustrated in the following non-limiting examples and in the accompanying drawings in which:

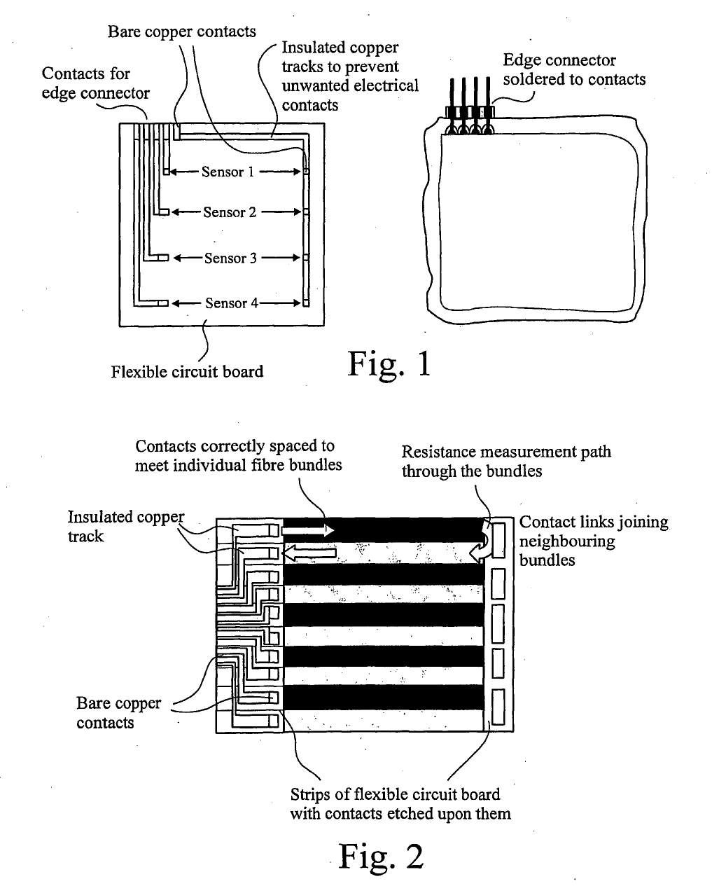

FIG. 1 (a) shows a schematic illustration of the layout of a flexible circuit board that can act as both the contact points and interleaves in a composite damage detection system;

FIG. 1 (b) shows an edge-connected composite panel;

FIG. 2 shows a schematic illustration of a damage detection system that removes the need for a continuous interleaf, reducing the contact strips to a thin strip that can be introduced into the component where it is required and wherein the second strip connects neighbouring fibre bundles, allowing interrogation of the damage detectors from one edge; and

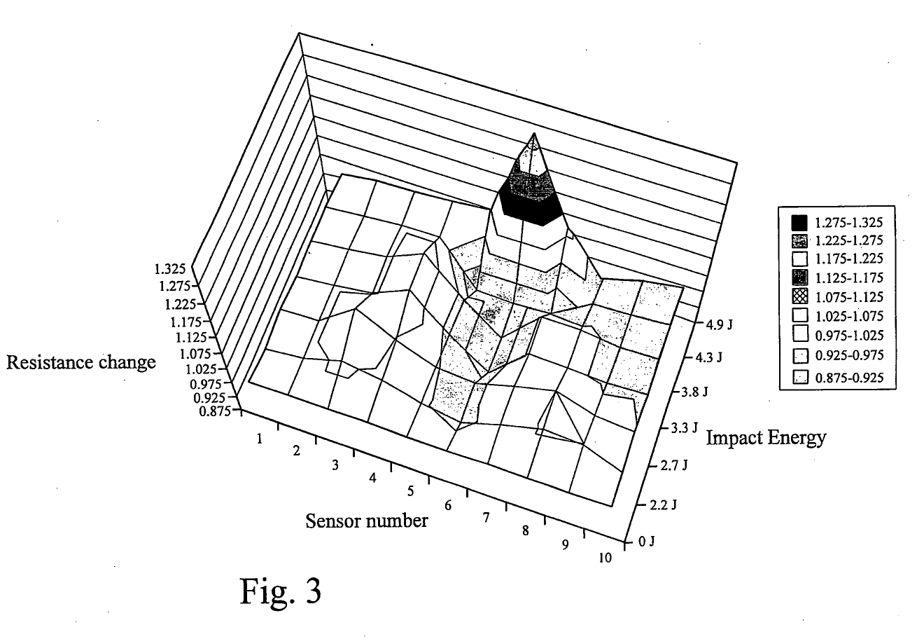

FIG. 3 shows a graph showing the results from an impact test using a sensor arrangement analogous to that shown in FIG. 2, and revealing the location and nature of the impact damage contained within the panel.

### EXAMPLE 1

A panel of composite material containing a sensing interleaf is manufactured from Hexcel FIBREDUX 913C-HTA(121e)-5-316 carbon fibre pre-preg with 913 matrix system, using the lay up sequence [02/I/902/03/903]s, with the presence of the interleaf being indicated by the I. The paired contacts of the Interleaf (of the form shown in FIG. 1) are positioned so as to align along the 0 degree direction of the panel. The composite is then cured in a laboratory pressclave using a pressure of 6 bar for a period of 1 hour at 120° C. before slow cooling to room temperature.

A flexible polyimide film circuit board is used as an interleaf to isolate the sensing plies from the rest of the composite panel. Electrodes are formed on the film by depositing a layer of copper and etching the appropriate shapes on the film. Once the electrode shapes have been etched an insulating lacquer is applied to the exposed copper to ensure that electrical contacts only occur where they are required. An example layout for sensing in one direction is shown in FIG. 1a, where tracks that bring the contact point to the edge of the panel are illustrated, as well as an earth line that acts as the second contact in each case. The flexible thin polyimide film circuit board is easily incorporated into the composite panel allowing the electrodes to be rapidly applied in one step, simplifying the manufacturing process. By leaving the edge electrodes uncovered an edge connector can be connected allowing easy connection to external instrumentation, and edge-cropping of the composite, as the electrodes can be routed to the desired location and made to the desired length. As the electrodes are all internally routed, they are also robust and difficult to break upon handling. The system is practically demonstrated as shown in FIG. 1b, with three contact pairs, and has been demonstrated to be capable of detecting a 2 mm hole drilled in the centre of the panel, without changes occurring in the two outer detectors.

### EXAMPLE 2

In an alternative realisation of a composite panel, where a complete interleaf is not necessary, the polyimide resin film can be used to provide rapidly applied contact points at some point within the panel (possibly an edge, or within the structure at a suitable location). The arrangement is illustrated in FIG. 2, using the same resins and manufacturing process as in Example 1. Here a single thin strip of the flexible polyimide resin film circuit board can be applied into the composite by hand, simplifying the manufacturing process. A second strip, applied at the opposite edge or another suitable location within the panel, can then act to connect neighbouring fibre bundles, allowing interrogation of the damage detection means from only one edge. This simplifies the connection process, and each detector of such a system can allow monitoring of the composite panel in a U-shaped array (FIG. 2).

To demonstrate this capability, specimens are prepared using a unidirectional carbon-fibre non-crimp fabric, into which signal wires are inserted at the end of each bundle of carbon-fibres, at one edge. At the other edge, U-shaped sections are inserted into each bundle of carbon fibres, linking neighbouring bundles. This arrangement is electrically analogous to the system shown in FIG. 2. To complete the composite, a further layer of carbon-fibre non-crimp fabric is placed on either side of the connected layer, and a layer of plain weave carbon-fibre fabric is placed on the outer faces of the panel. Huntsman LY564 and HY2954 are mixed in the ratio 100:30 and impregnated in to the fabrics to make composite with an approximate fibre volume fraction of 60%. Impact testing using a Davenport un-instrumented falling dart impact tower shows such a panel to be capable of detecting the occurrence of matrix-cracking and/or fibre fracture (FIG. 3). In this manner, full details of the damage within the composite can be obtained. The electrical system tested is analogous to a system using flexible printed circuit board, demonstrating that the use of thin strips of flexible polyimide film at the edge of the panel to provide the interconnections is practicable and only requires access to one panel edge. The reader's attention is directed to all papers and documents which are filed concurrently with or previous to this specification in connection with this application and which are open to public inspection with this specification, and the contents of all such papers and documents are incorporated herein by reference.

Embodiments of the present invention have been described with reference to using a change in resistance as being indicative of the presence of damage. However, one skilled in the art will appreciate that resistance is merely one of a number of possible measurable characteristics that can be used an indication of the presence. Other measurable characteristics, such as, for example, electrical characteristics, might include one or any combination of one or more of resistance, impedance, reactance, resistivity, capacitance, permittivity, elastance, conductance, admittance, susceptance, conductivity, reluctance, inductance, permeability, magnetic susceptibility, group delay or dispersion, transfer function, frequency and/or phase response, resonant frequency, Q-factor, propagation modes including TE/TM/TEM modes, cutoff frequency or wavelength and reflection coefficient could be used.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A composite material provided with a damage detection system, the composite material comprising a fibre-reinforced polymeric matrix, wherein the fibre reinforcement comprises electrically conductive fibres and the polymeric matrix comprises a thermosetting polymer and a thermoplastic polymer, and wherein detection means are provided to detect a change in a measurable characteristic of the composite material, said change in said measurable characteristic indicating the presence of at least one damaged area of the composite material, said detection means comprising a plurality of spaced apart electrodes mounted on an electrically insulating substrate and electrically connected to the electrically conducting fibres.

2. The composite material of claim 1, wherein the detection means is adapted to detect both the presence and the location of at least one damaged area of the composite material.

3. The composite material of claim 1, wherein the reinforcing fibres comprise carbon fibres, metal fibres, or metal coated polymeric fibres.

4. The composite material of claim 1, wherein the plurality of spaced apart electrodes is disposed along one or more edge regions of the composite material.

5. The composite material of claim 1, wherein the electrically conductive fibres are aligned axially and the electrodes are connected to opposed ends of the fibres.

6. The composite material of claim 1, further comprising a laminate of two or more fibre reinforcing layers, each containing electrically conductive fibres.

7. The composite material of claim 6, wherein the electrically conductive fibres of a first layer are aligned at an angle to the electrically conductive fibres of a second layer, and wherein each layer is separately provided with electrodes connected to its electrically conductive fibres.

8. The composite material of claim 1, wherein the electrodes are connected in use to resistance measuring and monitoring means having an output providing an indication of the position of an area of damage.

9. The composite material of claim 1, wherein the electrically insulating substrate is flexible.

10. The composite material of claim 1, wherein the electrically insulating substrate comprises a sheet or film of polymeric material.

11. The composite material of claim 10, wherein the polymeric material comprises an epoxy, a polyimide or a polyester film.

12. The composite material of claim 1, wherein the electrically insulating substrate is used as an interleaf to isolate the electrically conductive fibres from the composite material.

13. The composite material of claim 1, wherein the electrodes are etched from a metal film bonded to the electrically insulating substrate.

14. The composite material of claim 1, wherein the electrodes are coated with an insulating lacquer leaving exposed only those areas necessary to make electrical contact.

15. The composite material of claim 1, that is self-healing.

16. The composite material of claim 1, wherein the thermosetting polymer and the thermoplastic polymer together form a solid solution.

17. The composite material of claim 1, wherein the thermosetting polymer comprises a phenolic resin, a phenol-formaldehyde resin, an amine-formaldehyde resin, a urea-formaldehyde resin, a polyester resin, a urethane resin, an epoxy resin, an epoxy-polyester resin, an acrylic resin, an acrylic-urethane resin, a fluorovinyl resin; a cyanate ester resin; a polyimide resin or any other related high temperature thermosetting resin.

18. The composite material of claim 17, wherein the thermosetting polymer comprises an epoxy resin cured with a curing agent comprising an anhydride or an amine.

19. The composite material of claim 1, wherein the thermosetting polymer has a glass transition temperature Tg and the thermoplastic polymer has a fusion or flow temperature in the range Tg ±100° C.

20. The composite material of claim 18, wherein the thermoplastic polymer has a fusion or flow temperature in the range Tg ±50° C.

21. The composite material of claim 19, wherein the thermoplastic polymer has a fusion or flow temperature in the range of Tg ±10° C.

22. The composite material of claim 1, which comprises from 5 to 50% by weight of the thermoplastic polymer, based upon the total weight of the polymeric matrix.

23. The composite material of claim 1, wherein the thermoplastic polymer is wholly miscible with the thermosetting resin.

24. The composite material of claim 1, wherein the thermosetting polymer is an epoxy resin and wherein the thermoplastic polymer is polybisphenol-A-co-epichlorohydrin.

25. The composite material of claim 1, wherein the thermoplastic polymer does not chemically react with the thermosetting polymer at ambient temperatures.

26. (canceled)

27. The composite material of claim 1, wherein the measurable characteristic is an electrical characteristic.

28. The composite material of claim 1, wherein the measurable characteristic comprises one or any combination of one or more of resistance, impedance, reactance, resistivity, capacitance, permittivity, elastance, conductance, admittance, susceptance, conductivity, reluctance, inductance, permeability, magnetic susceptibility, group delay or dispersion, transfer function, frequency and/or phase response, resonant frequency, Q-factor, propagation modes including TE/TM/TEM modes, cutoff frequency or wavelength and reflection coefficient.

29. (canceled)

30. A method of detection damage in a composite material wherein there is used a composite material provided with damage detection means according to claim 1.

31. (canceled)

32. A method of repairing a damaged area in the composite material of claim 1, the method comprising heating the damaged area to the fusion temperature of the thermoplastic polymer.

33. The method of claim 32, wherein the damaged area is heated to a temperature of from the Tg of the thermoplastic polymer to Tg ±75° C.

34. The method of claim 32, wherein the electrically conductive fibres are used both for detection of the damaged area and for heating of the damaged area by resistance heating.

35. (canceled)
